(19) United States
(12) Patent Application Publication
(10) Pub. No.: US 2013/0206580 A1
(43) Pub. Date: Aug. 15, 2013

(54) CONTINUOUS COOLANT PURIFICATION PROCESS AND DEVICE

(71) Applicant: Oakwood Foods. LLC d/b/a Oakwood Technologies, (US)

(72) Inventor: JOHN MARBURGER, Indianapolis, IN (US)

(73) Assignee: Oakwood Foods. LLC d/b/a Oakwood Technologies, Indianapolis, IN (US)

(21) Appl. No.: 13/706,945

(22) Filed: Dec. 6, 2012

Related U.S. Application Data
(60) Provisional application No. 61/568,525, filed on Dec. 8, 2011.
(60) Provisional application No. 61/569,254, filed on Dec. 11, 2011.

(51) Int. Cl. B01D 3/10; C09K 5/20

(52) U.S. Cl. CPC B01D 3/10; C09K 5/20
USPC 203/41; 202/176

(57) ABSTRACT

A fluid processing device is provided for recycling a previously used water and glycol containing fluid by removing contaminants including hydrocarbon, metals, particulates and water contaminants from the water and glycol containing fluid. The device includes a particulate filter for removing particulates, an activated carbon filter for removing hydrocarbon contaminants, a micron-sized filter for removing at least one of particulate and metal contaminants, a high pressure membrane filter for removing contaminants and water, and a heater for heating the glycol containing fluid to a temperature at least near the boiling point of water in a predetermined reduced pressure atmosphere. The device also includes a low pressure separator having a tank kept generally at or near the predetermined reduced pressure for removing additional water from the water and glycol containing fluid. The low pressure separator includes a first exit port for removing separated water from the separator as steam, and a second exit port for removing substantially water free glycol based fluid from the low pressure separator.

### PRIORITY CLAIM

This application claims priority to U.S. Provisional Patent Application No. 61/568,525 filed on 7 Dec. 2011 and U.S. Provisional Patent Application No. 61/569,254 filed on 11 Dec. 2011, both of which are hereby fully incorporated by reference into this application.

### I. TECHNICAL FIELD OF THE INVENTION

The present invention relates to processes for separating desired chemicals from a mixture of chemicals, and more particularly, to a chemical separation process that has particular utility for re-cycling anti-freeze chemicals (e.g. Ethylene Glycol, Ethanol, Propylene Glycol), from a spent coolant mixture containing contaminants, including water.

### II. BACKGROUND OF THE INVENTION

Anti-freeze compositions are used in a wide variety of applications, such as motor vehicle coolant systems and industrial processes. Typical anti-freeze compositions include Ethylene Glycol and Propylene Glycol.

Anti-freeze serves as a coolant in a device such as motor vehicle engines wherein heat needs to be dissipated. An anti-freeze material is used by being mixed with water in a coolant system to depress the freezing point of water, and to raise the boiling point of the coolant water to allow coolant to function over a significantly wider range than would be possible using only water.

There are two primary types of anti-freeze compositions used currently. The most widely used type is ethylene glycol. A lesser used, but highly effective anti-freeze is propylene glycol. A typical vehicle anti-freeze composition will not only include ethylene or propylene glycol, but will also include a mixture of other materials known as “additives”. These additives help the performance of the coolant and help to preserve the coolant system in which they are incorporated. Examples of such additives include iron oxide, cadmium, and silicates. Additionally, dyes are often placed in the anti-freeze to impart a particular color to the anti-freeze composition.

Unfortunately, anti-freeze coolant compositions wear out after a certain period of time. Coolant exhaustion is usually caused by the coolant becoming contaminated with a variety of other contaminant by-products. Examples of these contaminants include such things as oil, cadmium, lead, copper and other residues of the initial coolant supplements.

Anti-freeze compositions are usually placed into a coolant system in a mixture with water. A typical anti-freeze/water mixture within an automobile coolant system is 50% ethylene glycol and 50% water. When it is “exhausted”, the percentage of ethylene glycol and water are within the removed coolant can vary over a very wide range.

In addition to ethylene glycol, propylene glycol is also used in several anti-freeze compositions. An advantage of the use of propylene glycol is that it tends to be less poisonous to pets than ethylene glycol. Spent coolant that is removed from automotive and industrial coolant systems can comprise a hazardous waste that should be dealt with appropriately to avoid environmental damage. Neither ethylene nor propylene glycol should be dumped directly into the ground or a sewer system because it will contaminate the ground and/or water and has the potential to harm humans, plant and/or animal life.

Fortunately, spent coolant that is removed from either an industrial facility or an automotive application is valuable enough to make reuse and recycling an economically viable proposition, at current prices. However, in order to re-use the glycol compositions, the spent coolant must be “cleaned” to reduce water and contaminant content. The cleaning process for cleaning the coolant quickly involves processes that (1) remove the water from the coolant, so that “cleansed composition” comprises greater than 90%-95% glycol materials with just a small residual water content; (2) remove particulate matter from the anti-freeze composition such as dirt, sand, grit and insoluble material; and (3) remove metals from the ethylene glycol such as metal salts, such as the cadmium, copper, lead, and other contaminant metals that find their way into the coolant, along with the coolant supplements that were originally introduced into the chemical.

Once the water-logged, contaminant containing coolant is cleaned up to form a generally water minimized, contaminant minimized “clean” glycol predominant anti-freeze composition, the cleansed anti-freeze composition can be reintroduced into another (or the same) coolant system as “recycled” coolant. This recycled coolant does have viability and can serve as well as fresh or new coolant in terms of its efficacy, and its lowered propensity to damage engine components, when compared to highly contaminated exhausted coolant.

There are several widely used methods for cleaning up spent coolant. One way to clean up the spent coolant involves employing a traditional distillation processes. In a traditional distillation process, two materials within a liquid mixture are separated by the application of heat, and the exploitation of the fact that different materials within the solution will boil off at different temperatures. In a distillation process, the lower temperature boiling product is baked off of the mixture and then re-condensed in a distillation condenser and then stored in a separate container. The high boiling point material remains behind in the heating vessel and is collected therein.

One difficulty with distillation based separations is that traditional distillation processes require large inputs of energy. In order to reduce these energy demands of traditional distillation, a less energy demanding process known as vacuum distillation has been employed for separating two liquids. Vacuum distillation operates theoretically similarly to a regular heat distillation process but takes advantage of the fact that the boiling temperature of a particular volatile material will vary with the pressure under which the material is placed. Therefore, by placing a particular volatile material under a lowered pressure, such as a partial vacuum, one can significantly reduce the temperature at which the material boils to thereby significantly reduce the amount of heat input (in kilocalories), that must be added to the volatile material in order to get it to boil off the mixture. In a typical heat distillation process of the prior art (carried out at standard or atmospheric pressure), the spent coolant mixture is heated to a temperature of approximately 212° F.-273° F. (100° C.-134° C.) to get the water to boil off of the glycol/water spent coolant mixture.

A typical vacuum distillation device of the prior art comprises a tank that includes a heating element for heating the glycol/water coolant mixture within the tank. A vacuum is pulled across the top of the tank (above the level of the liquid in the tank) to reduce the pressure in the tank. By so reducing the pressure within the tank, a typical glycol/water anti-freeze coolant mixture for ethylene glycol generally needs to be heated only to about 122° F.-153° F. (50°-67° C.) to reach a point where the water in the mixture will boil out of solution. Although the use of a vacuum does reduce the energy consumption process, room for improvement exists in the current vacuum distillation process.

One area for improvement relates to the efficiency of the process. In a typical prior art tank type process of the type described above, the vacuum that exists in the “air space” in the tank above the level of the liquid in the tank, actually only acts on the boiling point of that liquid at the surface of the liquid pool within the tank. As such, liquid under the surface of the pool is not being strongly impacted by the vacuum. Therefore, it usually takes some time for all of the liquid contained within the tank to be exposed to the vacuum to thereby boil off, which therefore extends the time necessary to boil off the water within the mixture and thereby purify the ethylene glycol.

Another drawback with typical vacuum distillation process is that a vacuum distillation process is usually done on a “batch” basis. As it is done on a batch basis, it usually requires that one particular batch of liquid be heated, and continuously be heated and boiled off until all of the water is boiled off and nothing but ethylene glycol remains. At the end of the cycle, the residue ethylene glycol (the “bottoms product”) is removed and a new batch of spent coolant is introduced into the vessel and heated.

Generally, a batch process is slower and less efficient than a continuous process. Therefore, it is one object of the present invention to provide a vacuum distillation process that removes water from an ethylene glycol/water coolant mix in a continuous, rather than batch like process.

Another technique that is often employed to help purify coolant, is through the use of filters. Filters are important to help trap particulate matter, to remove such particulates from the filter.

A further technique that is used within an anti-freeze purification process involves the use of an ion exchange resin to remove contaminants. An ion exchange resin works similarly to the manner in which a water softener works. The ion exchange method is used to remove metallic ions from the anti-freeze coolant. Through the removal of these metal ions, one can remove the harmful chemicals, such as copper, lead, cadmium and other chemicals from the mixture that would otherwise pollute the residue ethylene glycol, and might render the residue ethylene glycol unsuitable for use.

In addition, other technologies exist and are used in prior art processes for removing oil from the system. Examples of such technologies include flocculants such as alum (aluminum sulfate), ferrous chloride, and organic polymers. Known examples of prior devices that disclose methods and/or devices for recycling coolant include the following, the disclosures of which are incorporated herein by reference: Haddoch U.S. Published Patent Application No. 2002/0017491A1, published 14 Feb. 2002; Eaton U.S. Pat. No. 5,167,826 published 1 Dec. 1992; Beal et al. U.S. Pat. No. 5,262,013, issued 16 Nov. 1993; and Berke et al. U.S. Pat. No. 5,820,752 issued 13 Oct. 1998. One object of both the present invention and the prior art is to be able to produce a re-cycled coolant that meets or exceeds the standards for engine coolant set tforth in ASTM D3306-11 titled Standard Specification for Glycol Base Engine Coolant for Automotive and Light Duty Service.

Although the techniques discussed above do perform their function in a workman like manner, room for improvement exists. In particular, room for improvement exists in developing a system that has the potential for increased throughput, and also has the potential for reduced energy costs, so that the overall costs of purification of the ethylene glycol can be carried out in a cost-effective manner.

### III. SUMMARY OF THE INVENTION

In accordance with the present invention, a fluid processing device is provided for recycling a previously used water and glycol containing fluid by removing contaminants including hydrocarbon, metals, particulates and water contaminants from the water and glycol containing fluid. The device comprises a particulate filter for removing particulates, an activated carbon filer for removing hydrocarbon contaminants, a micron-sized filter for removing at least one of particulate and metal contaminants, a high pressure membrane filter for removing contaminants, and a heater for heating the glycol containing fluid to a temperature at least near the boiling point of water in a predetermined reduced pressure atmosphere. The device also includes a low pressure separator having a tank kept generally at or near the predetermined reduced pressure for removing additional water from the water and glycol containing fluid. The low pressure separator includes a first exit port for removing separated water from the separator as steam, and a second exit port for removing substantially water free glycol based fluid from the low pressure separator.

Several features and advantages obtained with the use of the present invention.

One feature of the coolant processor of the present invention is that the processor of the present invention has a compact, efficient design. This ability of the device is made compactly while still having high throughput rates, enable the device not only to take up less floor space within a treatment plant, but also enables the device to be designed to be portable, so that it can be movable between locations and be set up quickly which reduces start up costs.

It is envisioned that one of the most popular models of the present invention is likely to be a model that will be sized and configured to permit the processor to be housed within a typical ISO shipping container that is a typical transoceanic container. Such containers are typically sized so that they can be placed on the back of either a railroad flat bed car or a semi truck trailer and pulled over the road (or railroad) to their end destination.

Through the use of the present invention, a device can be created that is small enough to fit into one of the these containers, but still be quite large in its throughput. It is believed by the Applicants that such a sized device will have a projected maximum throughput of about up to 17,000 gallons (64,352 liters) to 20,000 gallons (75,708 liters) of spent coolant per day depending upon how the device is configured. The throughput capacity of the device will likely exceed the spent coolant output of many industrial facilities and many coolant collection and storage facilities. By making the device small enough to be portable, it is believed that the processor of the present invention will have the capacity to service a significant number of spent coolant using and collection facilities.

Another feature of the present invention is that it uses less filter materials when compared to the prior art. This feature has several advantages. One advantage is that it helps to reduce the cost of operation of the device, since lowering the required quantity of filter materials used requires less filter materials be purchased and cleaned, this likely resulting in cost savings.

Another advantage obtained by the use of fewer filters is that reducing the number of filters tends to reduce the maintenance costs of the system, since filters require both labor to install, and monies to purchase. Additionally, since the filters are often filled with contaminated materials, environmentally disposal costs are associated with them.

Another feature of the present invention is that it employs a continuous flow rate throughput. As discussed above, a continuous flow process is generally more efficient than batch flow processing, and can lead to a greater processing capacity for the device.

Another feature of the present invention is that it can be constructed modularly. This modular construction capability enables particular components within the device, to be substituted for counterparts of different size and operation type to thereby enable the user to re-configure the device to handle different materials and different throughput capacities. This modular construction helps to make the device more versatile insofar as it can be configured to handle a wider variety of fluids efficiently.

For example, it has been found by the Applicants that the oil content of the waste coolant will vary dramatically from batch to batch of waste coolant. One factor that affects the oil content is the source of the waste coolant. For example, the waste coolant collected at an automobile repair shop typically has a quite low oil content that is typically in the 5 to 10% range. However, a very different mixture of materials would be obtained from an automobile scrap yard since all waste fluids, including oil, coolant, transmission fluid, axle grease and the like, are typically collected in a single collection container (tank). A typical batch of waste coolant containing fluid from a scrap yard often contains between 30% and 50% waste oil by volume.

The modular construction of the present invention allows the oil processing unit to be removed and replaced with another oil processing unit that is more appropriately designed for handling high oil concentration fluids or low concentration oil fluids (as the case may warrant), and then used with the remainder of the machine. Interchanging the oil processing portion of the device, permits the same machine to handle a wide variety of different content-containing waste material streams, without the need to purchase several different systems for handling the different streams.

Another feature of the present invention, is that it uses a low pressure, low temperature processing process. Through the use of a vacuum distillation, the water can be boiled off the system at approximately 143° F. (62° C.), which is significantly less than a 212° F. (100° C.)-273° F. (134° C.) required at atmospheric pressure to boil off water from a coolant mixture.

The vacuum distillation process of the present invention provides a more efficient distillation because the water is treated so that the surface area of the spent coolant mixture (per volume of the mixture) that comes in contact with the vacuum is much greater than is traditionally achieved to thereby increase the efficiency of the vacuum distillation process. By increasing the efficiency of the vacuum distillation process, the energy costs for heating the water to its 143° F. (62° C.) separation point can be reduced substantially as compared to known prior art methods.

Another feature of the present invention is that it is highly efficient. The highly efficient nature of the process has the advantage of resulting in consistently high purity levels of the finished and fully processed anti-freeze glycol coolant. These consistently high purity levels have the advantage of enabling the recycled glycol fluid to be used in higher grade applications, and with less potential problems than less pure, recycled fluid.

Another feature of the process and device of the present invention is that it comprises a sealed system that discharges waste oil to a treatment or storage facility, prior to the glycol being separated from the water. This feature helps to create a purer glycol end product and a purer water end product.

Additionally, the present invention provides steam for distilled water as a by-product of the process. The use of steam as a by-product has the advantage of permitting the user to employ the steam a heat exchanger of the system to heat the water heater or the heat transfer part of the system. Additionally, the steam can also be used in a steam jacket to keep pipes warm where necessary.

Further, the distilled water that results from the condensed steam can also be used within the system, such as by adding it back to purified coolant, to help form a “premix” coolant. Typically, such premixed coolant comprises 50% water, 50% glycol mixture, and is sold along side of full strength anti-freeze in many facilities and retail outlets.

A further feature of the present invention is that it does a very highly effective job in trapping metal ions and metal solids. By trapping the metal ions and solids, the solids (such as salts) can be collected and disposed of appropriately. The metal ion waste trapped can be sold to metal smelters for metal recovery, and provide for income, and accountability of waste materials. Waste metals such as copper, lead and cadmium have a high value to smelters, and a high value for reuse.

Another feature of the present invention is that the coolant separation device is designed to be housed within a standard shipping container. By enabling the device to be designed for placement within a shipping container, such as a typical ISO shipping container, the modularity and portability of the device is significantly enhanced.

The portability of the device is enhanced because the shipping containers can be placed on the back of semi-trailer frames and flatbed railroad cars and can then be transported over the road (or railroad) to other locations. Additionally, the containers can help the modularization process so that as additional capacity is needed, additional containers full of processing equipment can be moved in and placed on-line in a processing site.

A further advantage of the containerization feature discussed above, is that one can design portable units that can be moved from plant to plant service a large number of plants. For example, as the present invention has the capacity of treating approximately 17,000 gallons (64,352 L) a day of waste material, an industrial plant producing 20,000 gallons (75,708 L) of waste coolant per month would only require the services of a treatment facility for about one or two days per month. The device of the present invention can be mounted on a semi-trailer and moved to another similar plant, so that over the course of a month, the same treatment device could be used to service potentially ten to twenty different plants, thus reducing the cost of equipment to all of the ten to twenty plants.

As discussed above, the modularity of the design permits the device to assume a plurality of different configurations to better handle, for example coolant waste having widely varying oil contents.

These and other features of the present invention will become apparent to those skilled in the art upon a review of the detailed description and drawings set forth below that represent the best mode of practicing the invention perceived by the Applicants.

### IV. BRIEF DESCRIPTIONS OF THE DRAWINGS

FIG. 1 is a schematic view of the various components of the recycling device of the present invention for schematically illustrating both of the device and the process;

FIG. 2 is an enlarged partial view of the schematic of FIG. 1, showing that portion of the device and process in that portion of FIG. 1 between the lines labeled FIG. 2-FIG. 2 of FIG. 1;

FIG. 3 is an enlarged partial view of the schematic of FIG. 1 showing that portion of the device and process in that portion of FIG. 1, contained between lines labeled FIG. 3-FIG. 3 of FIG. 1;

FIG. 4 is an enlarged partial view of the schematic of FIG. 1, showing that portion of the device and process in that portion of FIG. 1 contained between the lines labeled FIG. 4-FIG. 4 of FIG. 1;

FIG. 5 is a table showing the various symbols used to denote particular components in the other figures;

FIG. 6 is a partially schematic view of a low pressure glycol/water separator used in connection with the present invention;

FIG. 7 is an exploded, somewhat schematic view of the vertical barrel assembly of the low pressure separator unit shown in FIG. 6;

FIG. 7A is a sectional view of an alternate embodiment lid for a barrel separator assembly;

FIG. 7B is a sectional view of barrel assembly including an alternate embodiment coolant spray system for dispensing coolant on the spinning disks of the separator;

FIG. 8 is another, exploded view of an alternate embodiment, vertical barrel assembly, used in connection with the low pressure separator shown in FIG. 6; and

FIGS. 9A and 9B, taken together comprise a highly schematic view of an alternate embodiment continuous coolant purification process and device.

### V. DETAILED DESCRIPTION

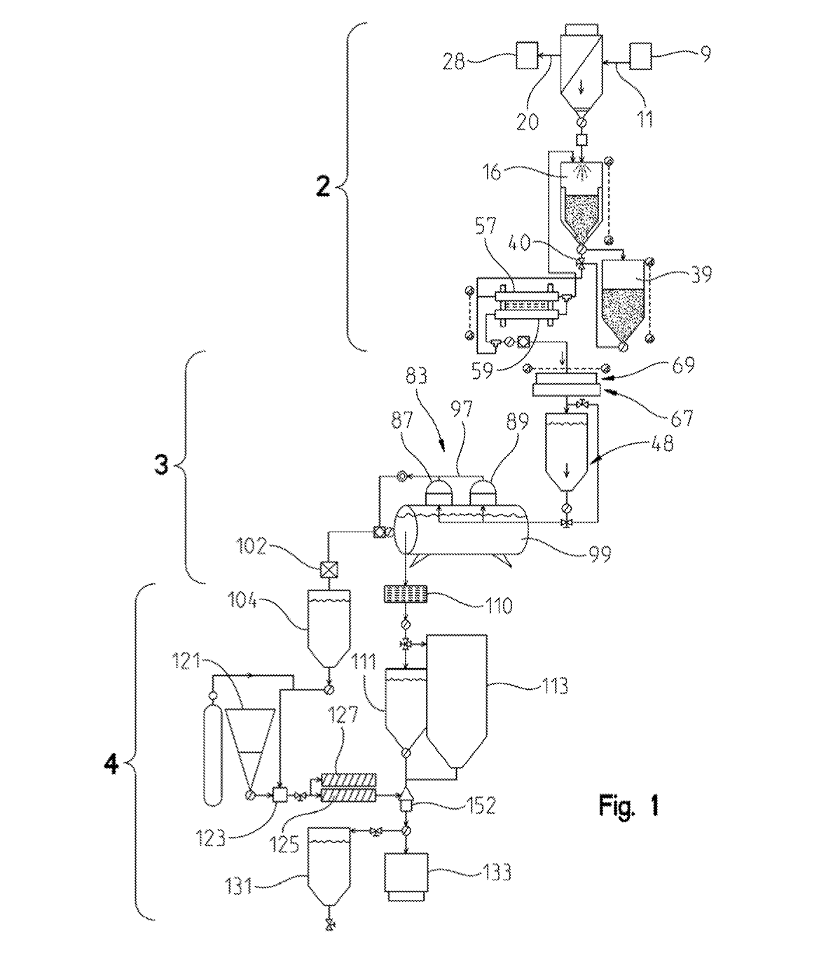

FIGS. 1-4 show schematic representations of the components employed with the device and process of the present invention. The furthest upstream component in the device 10 is an inflow pipe 11 for taking the material from a waste coolant collection tank 19 and delivering the waste coolant into the system 10. The waste collection tank 19 can comprise, for example, a fixedly positioned 6,000 gallon tank, or else a portable tank such as a truck mounted tank.

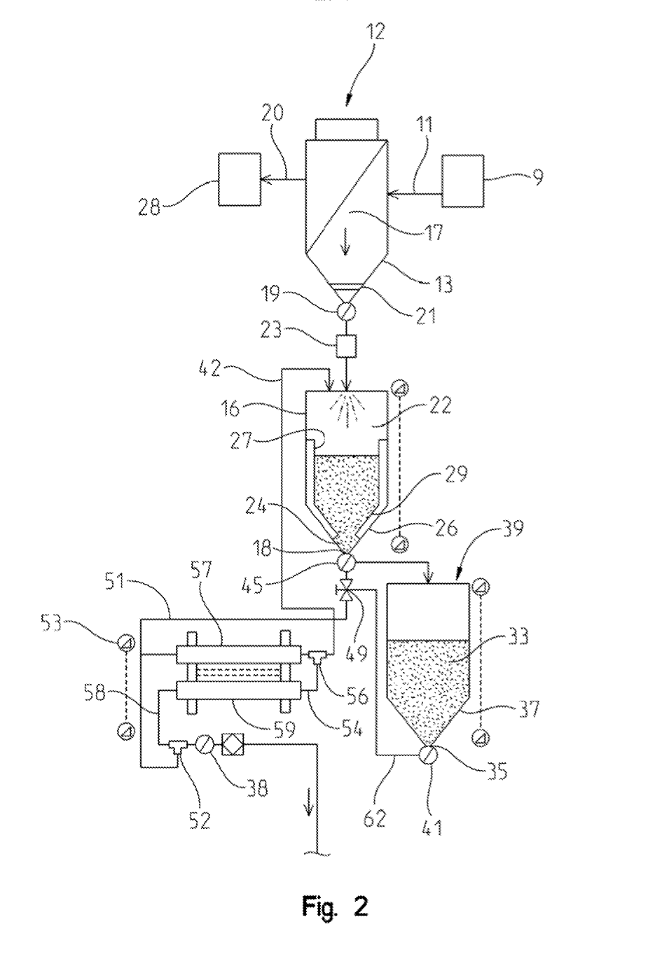

The waste coolant/water mixture flows through the inlet pipe 11 into an oil separator 12. Oil separator 12 is tank-like in configuration and can employ one of several technologies to separate oil in the mixture from the remainder of the mixture. The oil separator 12 can employ a “cone tank”, having an inverted conical lower portion that enables oil and water to be separated by placing the oil/water mixture (here coolant/oil mixture) into a generally quiescent tank, having a conical bottom portion 13 (FIG. 2). Generally polar compounds, such as an ethylene glycol/water coolant tend to intermix with each other and to separate out from non-polar compounds, such as oils and other non-polar hydrocarbons. Therefore, these differences in polarity will separate the hydrophobic oil from the hydrophillic spent glycol and water in the spent coolant. Because the oil fraction has a lower density than the coolant/water fraction, the oil fraction will generally collect as a top, supernatant layer in the tank 12, and the spent glycol and water fraction will collect as the lower “bottoms” fraction in the bottom of the tank below the supernatant layer. Separated oil that is pulled off of the separator 12 travels through outlet pipe 20 to a waste oil storage tank 28 (FIG. 1).

A valve 15 disposed adjacent the lowest position of the tank 12, controls the flow of the spent coolant/water mixture out of the bottom of the tank 12, and controls the flow of the spent, but oil-content-reduced glycol/water out of the bottom of the tank 12. The flow of spent glycol/water should be controlled to allow the spent glycol/water mixture to flow out of the bottom of tank 12 until the point where one reaches the oil layer. The valve 15 should then be shut to prevent the oil from flowing through the lower portion of the tank. The addition of more spent coolant to the collection tank 12 would lead to the next batch of spent coolant for which tank 12 could be employed for separating oil from the remainder of the mixture that could be removed.

The desired flow rate of fluid through the oil and water separator can be determined by the user's preference based on the desired throughput rate for the device 10. In two exemplary embodiments of the Applicants' device, oil water separators were chosen having flow rates of 7 gpm (gallons per minute) and 12 gpm.

The oil separation tank 12 can include an oil float switch 17 that floats between the lower glycol/water fraction and the upper oil fraction. The float switch 17 can be operatively coupled to open the exit valve 15 of the tank 12. When the flow switch 17 rises above a pre-determined upper level, the switch opens valve 16 to allow spent water/glycol mixture through the valve 16 and out of the bottom of the tank 12. Conversely, valve 15 of the tank 12 is closed, when the water/glycol mixtures reaches a pre-determined lower level, so that oil in the oil fraction does not flow through the valve and out of the bottom of the separator 10, thus ensuring that the glycol/water mix flowing out of tank 12 has a reduced oil content.

In addition to the quiescent oil tank 12, other technologies exist for separating out oil. For example, water separators exist, that use combinations of filters, materials, and centrifugal separation to separate non-polar oil compounds from polar compounds such as spent water and spent coolant mixtures and the like. One or more of these systems can be used either in place of, or in addition to the quiescent holding tank 12. Examples of prior art oil separation technologies can be found in the following patents, the disclosures of which are incorporated herein by reference: Warren et al. U.S. Pat. No. 6,485,634 issued 26 Nov. 2002; Int Veld, U.S. Pat. No. 3,957,638, issued 18 May 1976; Terrien et al. U.S. Pat. No. 6,315,131 issued 13 Nov. 1981; Simpson et al. U.S. Pat. No. 4,414,112, issued 8 Nov. 1983; Schmidt et al. U.S. Pat. No. 4,802,978 issued 7 Feb. 1989; and Terrien et al. U.S. Pat. No. 7,160,473.

It is believed that technology such as that described above (in connection with the present invention) is capable of removing a substantial portion of the oil within the coolant/water mix, so that the outflow from the bottom of tank 12 through exit valve 15 contains only “entrained oil”. Entrained oil typically comprises about three percent (3%) of the spent water/coolant that passes through the exit valve 15. A first pump 19 can be provided, if necessary, to pump the emerging spent coolant SC to bag filter 16.

An example of a pump that will serve well as first pump 19 is a Ampco centrifugal force, 2.5 inch/7.5 hp, stainless steel pump with a 5 inch impeller. It is understood that the particular types of pumps chosen for use in the present invention are chosen based on criteria such as flow rate, distance the fluid needs to be pumped, height above the pump to which the fluid needs to be pumped, cost of the pump, reliability and corrosion resistance of the pump, desired out put pressure of the pump, size of the pump and energy demands and other costs of operation issues presented by the pump. As such, the way in which the various components are configured, will have an influence on pump size, as the need for a pump could be eliminated (or its size and power reduced), if the fluid is being transferred generally vertically from an upper, upstream component to a lower, downstream component.

The coolant/entrained oil mixture is then directed by the pump 19 into a bag filter 16, after it emerges from oil separator 12. Magnets 21, 23 may be employed to pull magnetic particles, such as metal contaminants out of the system, such as iron shavings picked up by the coolant from the engine conduit system.

After passing through the magnets 21, 25 and pump 19, the spent coolant mixture SC is delivered into a spigot 25 that is disposed at the upper portion of the bag filter 16. The spigot 25 is moveable between an open and closed position to control the flow of fluid there through and, directs the flow of the fluid into the bag filter 16 where it is placed in a tank on a first or upstream side 22 of a filter element 27. Since gravity serves as an efficient mover of fluid, the upstream side 22 of the filter element 27 is preferably disposed above the downstream side 24 of the filter element.

The bag filter includes a container 29 having an outlet valve 18 disposed at its bottom, and a bag type filter member 77, that divides the bag filter 16 into an upstream side 22 and a downstream side 24. In order for the mixture material to travel from the upstream side 22 of the filter element 27 to the downstream side 24 of the filter element 27, the material must pass through the actual filter element 27 itself. Examples of bag filters that will work with the present invention are two-micron bag filters and four micron type bag filters.

Bag filters 16 such as the one described above have the advantage of being very cost-effective to use. Although they are cost effective to use, they are not highly efficient and generally are believed to be about 70% efficient. By 70% efficient, it is meant that for example, a 4 micron bag filter element 27 will pick up and trap 70% of the particles that pass through it that are 4 microns or bigger, while allowing 30% of such particles to pass there through.

Because of this purification level, the spent coolant should be further purified to remove more particulates. To accomplish this, the fluid is passed through and emerges from the bag filter element 27 and then is passed through a string-wound filter 26 disposed downstream of the bag filter element 27. The string wound filter 26 is more efficient than a bag filter, and typically has about a 90% to 92% efficiency ratio, although string wound filters 26 are typically more expensive. As such, only two percent of the four micron particles will pass through a four micron string wound filter 26.

The fluid that passes through both the bag filter 27 and string wound filter 26 is substantially devoid of particulates, with greater than 92% of the particulates being stripped out by the bag filter 16 and the string wound filter 26. A second pump 45 is disposed in the outflow pipe downstream of the string wound filter 26 to pump the emergent fluid to the next station, which comprises the activated carbon filter 33.

Although the activated charcoal filter 33 does trap some particulates in the fluid flowing there through, its primary job is to remove hydrocarbons from the fluid. As alluded to above, even though the oil water separator 12 has removed a significant amount of oil from the spent coolant, it is not unusual for the processed partially spent coolant fluid to still contain about three percent entrained oil. This three percent entrained oil is largely captured by the activated carbon filter 33 and thereby removed from the partially processed fluid.

In addition, activated carbon filters 33 can also capture, and therefore remove certain non-oil hydrocarbon containing materials such as chlorinated hydrocarbons, and other understandable hydrocarbon-containing materials. Further, the carbon filter 33 can serve to remove and capture some metallic ions, such as mercury and others.

The active carbon filter 39 preferably includes 50 mesh charcoal, and a back up 40 mesh filter. The carbon filter also includes an outlet 35 at its bottom, as the activated carbon of the carbon filter 39 is preferably disposed within a conical bottom 37 of the tank that comprises the carbon filter 39. A third pump 41 is provided downstream of the carbon filter for piping the fluid to the next station. Pump 41 can be similar to first pump 19 described above, and similar criteria are employed to select the particular make and model of pump selected for use as pump 41.

The effluent from the active charcoal filter 33 is then suitable for directing to a downstream component such as membrane separators 57, 59. The effluent passes through pump 41 and outflow line 62 and is directed to pass through valve 49, that can be set to either direct the effluent downstream to membrane separator 57, or back to the inlet of carbon filter 39 so that the effluent can be further purified by making a second pass through the active carbon filter 39. Additionally, the effluent can be directed to divert fluid to the upstream part of the bag filter 27, so that the fluid will be re-circulated through each of the bag filter 27, string filter 26 and charcoal filter 39. In one especially preferred embodiment, the device is configured so that 30% of the effluent from the charcoal filter 26 is directed downstream to the downstream components such as the membrane filter and vacuum separator, and 70% of the fluid is re-circulated through the bag filter 27, string filter 26 and charcoal filter 26.

Additionally, the piping can be configured to allow valve 49 to direct the outflow of second pump 45 or the reverse flow through piping 51 to flow “backwards” through piping 52 to back flush and thereby clean the activated carbon and charcoal in the active carbon filter 39. The back flush liquid can either be re-circulated through the system or treated separately.

Normally, the effluent that emerges from the downstream end of the activated carbon filter 39 is pumped by pump 41 to valve 49, that directs it into the inflow pipe 51 that directs the partially processed coolant/water mixture through a valve 53 which directs the partially processed coolant/water mix into the primary membrane separator 57. The downstream end of the primary membrane separator 57 is connected to a valve and T-Junction 56 so that the effluent from the primary membrane filter 57 can be directed to either the secondary membrane filter 59 for further processing, or else, directed into piping 42 which directs the fluid to the upstream end of the bag filter 22 string wound filter. If so desired, the partially processed fluid will be re-circulated through the bag filter 22 and activated charcoal filter 39. The membrane filters are employed to further remove enhanced water from the spent coolant mixture.

Alternately, the fluid in piping 51 can be directed to by-pass the membrane separators 57, 59 and instead be directed to T-Junction 52. It will also be noted that effluent from the downstream end of secondary membrane 59 is conducted by piping 58 to the T-Junction/Valve 52. Downstream from T-Junction/Valve 52 is a pump 38. Pump 38 is preferably a high pressure pump such as a 600 PSI Giant Brand High Pressure Pump.

The primary 57 and secondary 59 membrane separators are part of a membrane separation unit 55. The primary 57 and secondary membrane separator 59 have passages for the flow of fluid there through that are in the nanometer range of somewhere generally less than about 35 nanometers. A wide variety of potentially different sized membranes are useable and are available from Dow Chemical Company. The choice of the particular membranes 57, 59 to use is dependant upon the application, with smaller membranes (pore size) having more highly refined separation abilities, but also having a lower throughout rate thereby making such smaller pore size membranes more expensive and less cost-effective to use.

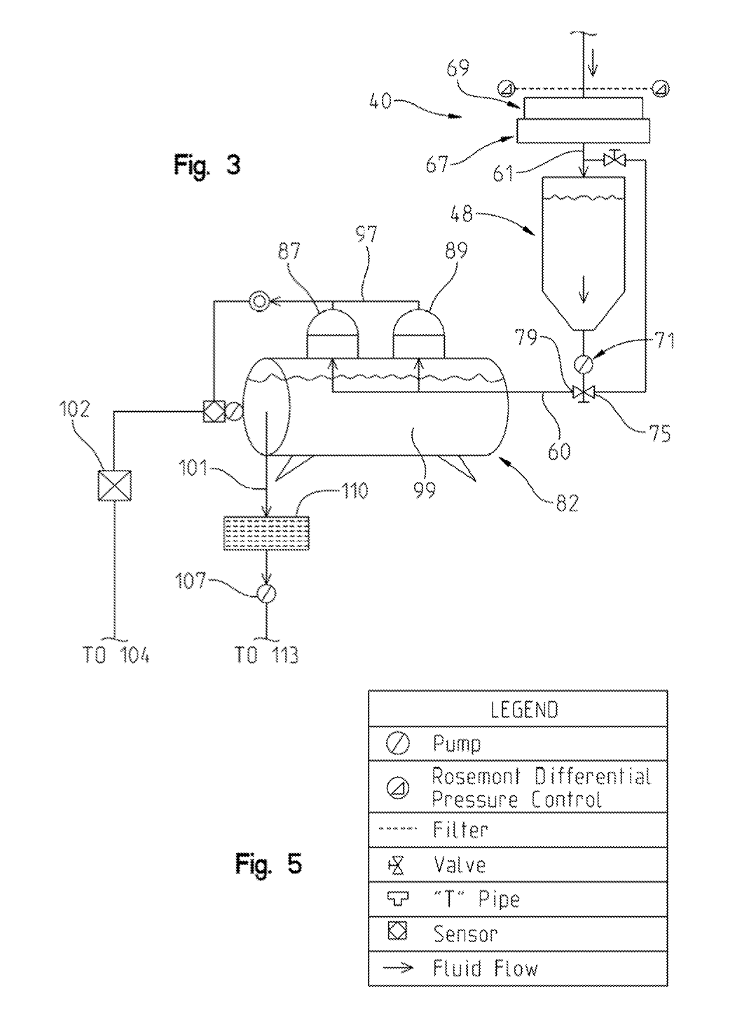

The passage of the fluid through the membranes 57, 59 of the micron separators 55 helps to filter the fluid through an osmosis process that is not unlike that osmosis process used currently in the manufacture of products, such as fruit juices and the like. The effluent from the micron membrane separator 55 has a lower water content than the water that enters the membrane separators 57, 59. The effluent is then passed through a pump 38, and into a filter unit 40 (FIG. 3).

The effluent to be treated then passes through a filter within filter unit 40. The purpose of the filters within the filter unit 40 is to filter out whatever particulate matter remains within the mixture prior to the mixture being transferred to the heat transfer tank 48 for heating. Preferably, the filter unit 40 comprises a two stage filter, including a primary ten micron filter 67 and a secondary five micron filter 69.

The effluent that has been processed by the primary 67 and secondary 69 filters of the filter unit 40 and has emerged from the downstream port of filter 40 is then directed through piping 61 into the upstream port of a heat transfer tank 48. The heat transfer tank 48 serves to heat the fluid to between approximately 122° F. (50° C.) and 153° F. (67° C.) and preferably closer to 144° F. (62° C.), which is the temperature at which the vacuum separator operates most efficiently to separate water from the glycol in the spent coolant mixture.

There are several methods for applying heat to the spent coolant to heat it in the heat transfer tank 48. Preferably, electrical and/or gas heating elements can be employed to provide the bulk of the heat to the spent coolant fluid in the heat transfer tank 48. Additionally, the steam formed as a byproduct of the vacuum distillation can be used to heat the material within the heat transfer tank 48 or to provide a steam jacket to the tank 48 to help maintain heat within the tank 48. Examples of heat transfer tanks include a plurality of commercially available industrial strength and industrial sized water heaters, that are currently available in the market place.

Preferably, heat transfer tank 48 should be sized to heat water therein continuously up to the desired temperature 143° F. (61.6° C.) to help ensure that one could use a continuous flow process and not have to slow down the process while one waited for a batch of water in the tank 48 to heat sufficiently to be hot enough to transfer to the vacuum separator. Additionally, a multi-stage heat transfer tank 48 could be used, if such were found to be more efficient or to provide a back up so that continuous flow could be achieved.

The water that flows out of the heat transfer tank 48 flows through a pump 71 and into a diverter valve 75. The diverter valve 75 is capable of recirculating hot water bank into the heat transfer tank 48, to help maintain the water in the heat transfer tank 48 at a constant temperature. Additionally, the diverter valve 75 has an outlet 79 for diverting water into the vacuum separator 83.

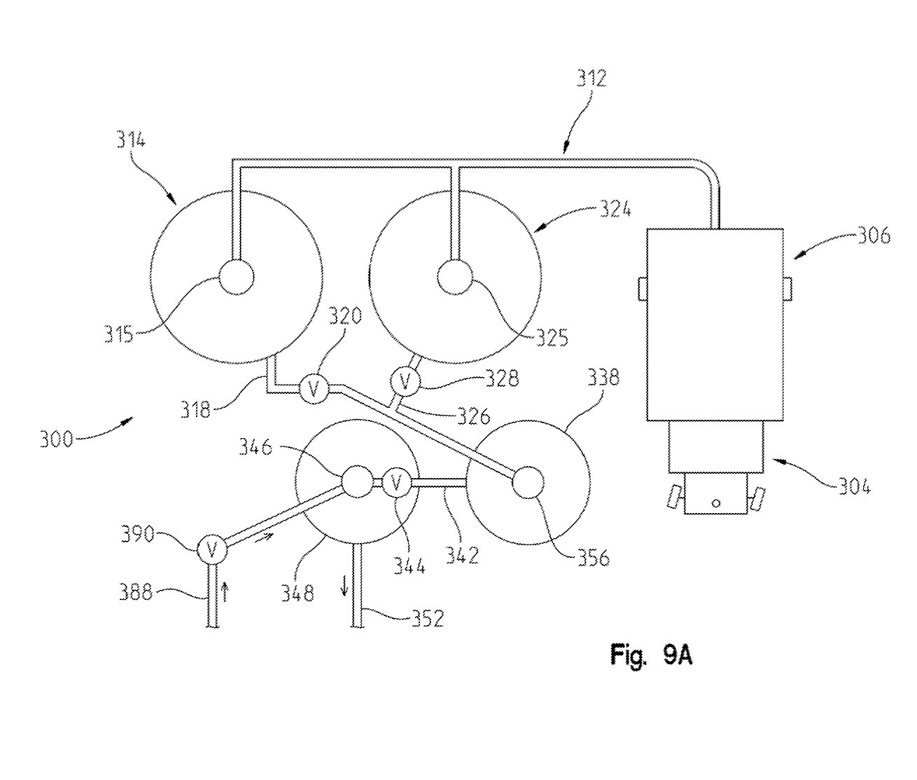

The vacuum separator 83 is best shown in FIGS. 3, 6, 7, and 8. The vacuum separator 83 of the present invention is schematically shown in FIGS. 3 and 6-8 as having a “two-head 87, 89 unit”. By two-head unit it is meant that the device includes two spinning discs assembly units 87, 89 that serve as a primary component of the vacuum separator 83 of the present invention.

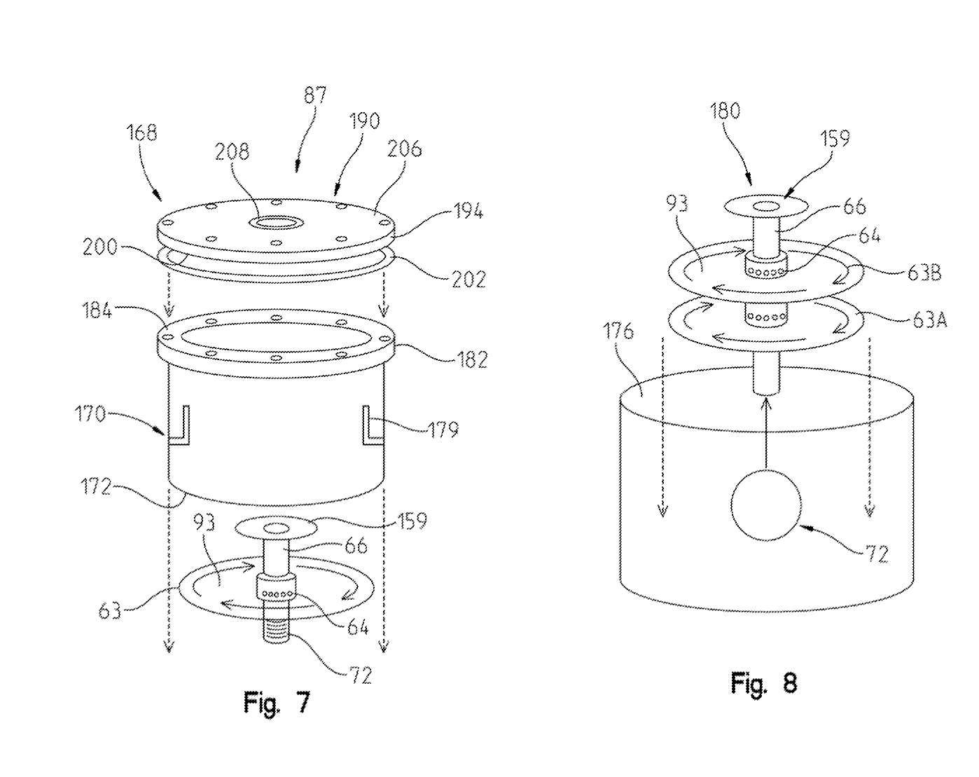

The vacuum separator 83 includes an inflow pipe 60 for directing water into the vacuum chamber 91. A pump 71 is used for pumping fluid through inflow pipe 60 and into vacuum separator 83. Although pump 71 is preferably disposed upstream of the diverter valve 75 as shown in FIG. 3, the pump 71 can be disposed downstream of the diverter valve 75 in inflow line 60 as shown in FIG. 6. Alternately, if necessary because of distance or pressure requirements, the inflow pump 71 can be a second pump that is used in connection with the pump that is disposed upstream of the diverter valve 75. A vacuum pump (not shown) is provided for maintaining a vacuum inside tank 99 of vacuum separator 83. A control panel 152 is operating coupled to a level sensor 155 for detecting the level of fluid in the tank, moisture sensor 154 and temperature gauge 161 to enable the control panel 152 to monitor the operational parameters of the separator 83 to better control its operation.

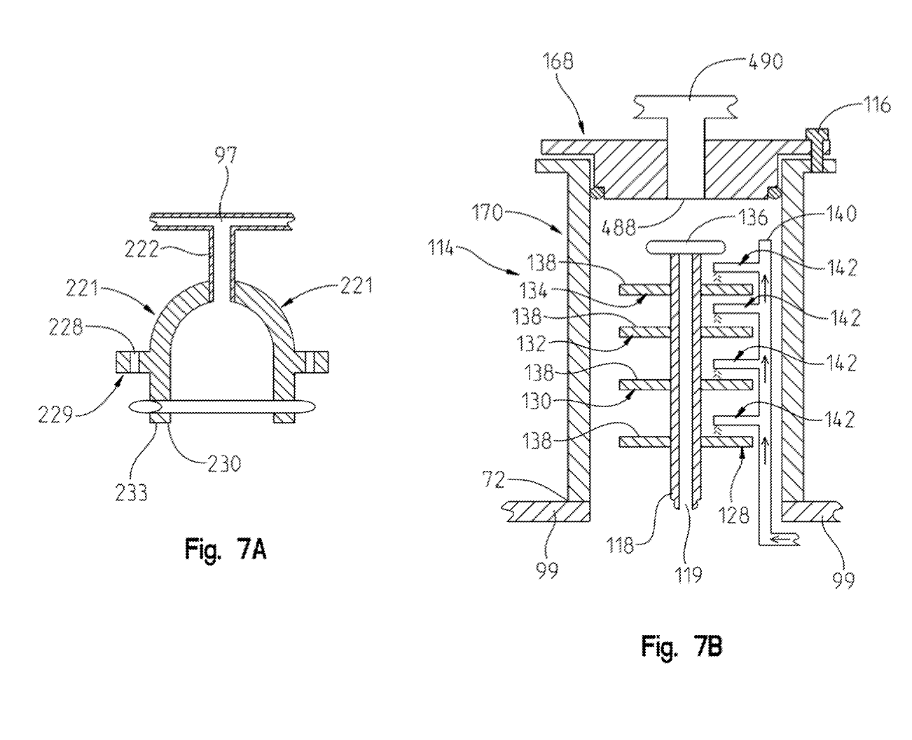

Water then passes up through the inflow pipe 60, and is then directed into branch pipes 72, 76 which direct the water into the first 87 and second 89 spinning head barrel assembly. The water inflow pipe 60 includes a series of outflow ports 64 that are disposed circumferentially around a pipe 60 (FIG. 7). The water is directed radially outwardly of the outflow ports 64 onto a disc member 63.

The low pressure spinning separator 87 of the vacuum separator 83 is best shown in FIGS. 3, 6, 7 and 8 as including a barrel assembly 168, that is coupled to the top edge of the tank portion 99 of the vacuum separator 83. Spin separator 87 is identical to spin separator 89, and hence, only spin separator 87 will be described to avoid duplicate descriptions.

The barrel assembly 168 includes a generally cylindrical housing 170, having a lower edge 172 that is coupled to the upper surface 174 of the tank 99. A mounting saddle (not shown) can be placed on the upper surface of the tank, if a rounded top tank is employed. The saddle and/or tank 99 can include a coupling mechanism, such as aligned apertures, a bayonet mount, or the like, for mounting the barrel assembly 168 to the tank portion 99. Alternately, the barrel assembly 168 can have its generally cylindrical housing 170 welded to the tank member 99. Cylindrical housing 170 includes an inner wall 176, that defines a hollow interior 178. Mounting brackets are mounted in the interior on the inner wall 176 and disposed in the hollow interior 178, for holding the evaporation disk assembly 180.

The upper portion of the cylindrical housing 170 includes a radially outwardly extending flange portion 182, that is approximately one half inch thick, in a preferred embodiment. The primary components of the barrel assembly 168, are made from stainless steel, including the cylindrical housing 170, lid 190, air motor, mounting brackets the shaft, bolts and disks 93.

The radially outwardly extending flange 182 includes a series of vertically extending bolt receiving apertures 184 holes, that are provided for receiving one half inch (SAE) flange bolts. Because of the high vacuum achieved within the tank 99 and vacuum separators 87, 89, it is important to use extra heavy-duty materials, that can resist collapsing under the vacuum pulled in the interior of the tank 99 and barrel assembly 168.

A lid 190 is shown as being generally disk-shaped in FIG. 7, and is sized and configured for placement over the open top end of the cylindrical housing 170. The lid includes an outwardly disposed enlarged diameter portion 194, and an inwardly disposed reduced diameter portion 200. The reduced diameter portion 200 is sized for being received within the interior 178 of the tank. The distal end of the reduced diameter portion can be formed to include an annular groove for receiving an annular sealing gasket 200. The sealing gasket 200 is preferably made from a Viton® material. Viton® is a brand of synthetic rubber and fluoropolymer elastomer manufactured by DuPont Performance Elastomers LLC that is commonly used in O-rings and other molded or extruded goods.

The enlarged diameter portion 194 is designed to have an underside surface that is sized and positioned to be received on the upper axially outwardly facing surface of flange 182. Enlarged diameter portion 194 is approximately one-half inch (1.27 cm) thick, as is the reduced diameter portion 200.

A series of bolt holes 206 extend circumferentially around the outer portion of the enlarged diameter portion 94 and are sized, configured and positioned to align with the bolt holes 184 that are formed in the flange 182 of the cylindrical housing 170. The lid 190 also includes a central aperture 208. The central aperture 208 includes female threads, for threadedly receiving an outlet pipe, that as shown in FIG. 6 can be either a part of, or coupled to outflow pipe 97. An air motor 159 is coupled to the upper end of shaft 66. A powered air source (not shown) is provided for causing the air motor to open shaft 66 and disks 63 at a high rate, and preferably at about 1750 rpm.

Turning now to FIG. 7A, an alternate embodiment lid 221 is shown. Lid 221 is dome-shaped, and is believed to function better than the planar lid 190, since the dome-shaped lid 221 is better configured for more efficiently removing water vapor from the tank.

The dome-shaped lid 221 shown in FIG. 7A includes a lower connector portion that includes an enlarged diameter portion 229, and a reduced diameter portion 218. The enlarged diameter portion 229 and reduced diameter portion 230 should be configured in size similarly to the enlarged diameter portion 194 and reduced diameter portion 200 of the disk-like lid 190, as they serve the same purpose, and also engage the radially outwardly extending flange 182 of the cylindrical housing 170. A Viton gasket 233 can be affixed to a groove on the reduced diameter portion 230 to sealingly engage the dome lid 221 to the cylindrical housing 170, to prevent leaks to thereby enable a vacuum to be maintained in the interior of the tank 99 and barrel assembly 168.

The dome lid 221 includes a central aperture 222 having female threads to which a male threaded outflow pipe 97 can be coupled. The purpose of the outflow pipe 97 is to carry away separated water from the vacuum separation to either further treatment of the water, or a storage tank for the distilled water. The working components of the separator 87, 89 are the spinning disks 63 which promote the evaporation (removal of water from the glycol/water mixture of the spent coolant. The evaporation disks 63 are a primary functional operator for providing increasing the surface area of the liquid coolant mixture that is exposed to the vacuum within the vacuum separator, to thereby speed up and make more efficient the separation of the water in the spent coolant mixture from the glycol in the spent coolant mixture. Ultimately, the enhanced efficiency increases the throughput rate of the device, and correspondingly reduces processing costs.

The water/coolant that flows out of the outlet port 64 impacts the spinning stainless steel evaporating disc 63 by being deposited onto the upper surface 93 (FIG. 7) of the disc 63 in a thin film. When in a such film, the water/coolant mixture has a large surface area to volume ratio. The vacuum, when coupled with the heated nature of the fluid, tends to drive off the water from the mixture by boiling off the water, and thereby separate the water from the anti-freeze compositions in the spent coolant mixture.

This could be technically expressed as the water in the coolant reaching the vapor pressure of water at its boiling point to thereby cause the water to go into a vapor or heated steam state. Water in the form of steam is then removed from the vacuum separator 83 and transferred through pipe 97, into a condenser 102 (FIG. 3) that ultimately delivers the condensed water into a distilled water tank 104.

The material deposited on to upper surface 93 of the disk 63 travels in a thin film radially outwardly on the surface 93 of the spinning disc 63. By the time the material reaches the radially outer edge of the spinning disc 63, most of the water is removed and a more highly concentrated glycol is the rendering material on the disk. When the glycol reaches the outer edge of the disk 63, the glycol falls radially and downwardly and then drops down into the tank portion 99 of the separator 83. The glycol that flows out of the glycol catch tank is then delivered by pipe 101 into a molecular sieve 110.

Turning now to FIG. 7B, an alternate embodiment barrel assembly for a low pressure separator 114 is shown. The primary difference between the low pressure separator 114 shown in FIG. 7B, and the low pressure separator 87 shown in FIG. 7 resides in the coolant introduction pipe 140 and spray nozzles 142. Rather than coolant being delivered through the central pipe, a radially outwardly disposed water introduction pipe 140 is provided that includes a plurality of spray arms 142. The spray arms extend over the upper surface 138 of the first, second, third and fourth spinning disks 128, 130, 132, 134 respectively, and spray out water near the radially inner portion of the inner surfaces 138 of the disks 128-134. The water so disbursed then travels radially outwardly, and operates in essentially the same manner as is discussed in connection with barrel separator 87 of FIG. 7.

It will be noted that the central mounting pipe 118 may or may not have a hollow interior 119. Rather than serving as a conduit for water, the primary purpose of the central mounting pipe 118 is to serve as a spindle on which the spinning circular disks 128-134 are mounted. In other respects, the barrel assembly separator 114 is generally similar to barrel separator 87 shown in FIG. 7, as it includes a cylindrical barrel portion 170 and a lid 168. The lid 168 has an outwardly extending flange including bolt holes through which bolts 116 can pass for coupling the lid 168 to a radially outwardly directed flange disposed at the top of the barrel 170.

A mounting member 72 is provided for coupling the lower end of the barrel 170 onto the upper surface 190 of the tank.

One advantage of the barrel assembly shown in FIG. 7B is that it is somewhat easier to fabricate, since the water introduction pipe is generally stationarily positioned, as are the spray heads 142, there is no need to worry about bearings and seals in a spinning water introduction pipe, as is required in connection with the embodiment shown in FIG. 7. Nonetheless, bearings are necessary for the disk mounting pipe 118, since the air motor causes the pipe 118 to spin, to therefore cause the disks 128, 130, 132, 134 to spin in a manner similar to that disclosed in connection with FIG. 7.

The molecular sieve 110 is a ceramic device having two to four micron-sized pores. These pores are designed to catch small amounts of latent water that still resides in the separated glycol. The glycol that emerges from the molecular sieve 110 is more highly purified and polished.

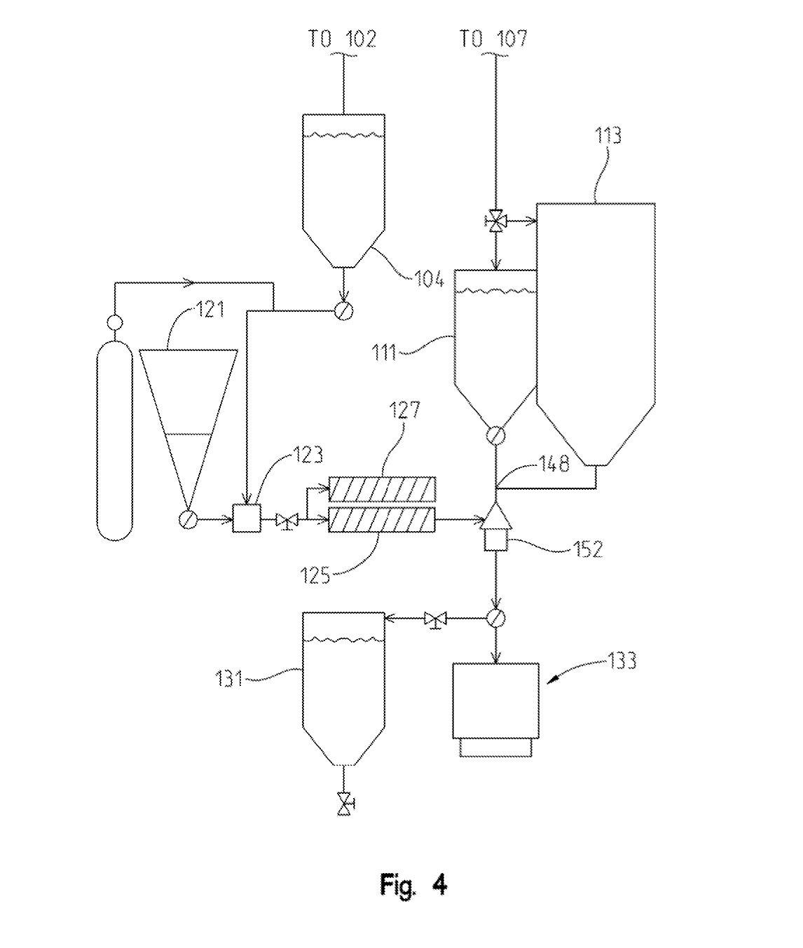

The resulting glycol that emerges from the molecular sieve 110 (FIG. 3) is believed by the Applicants to be able to a level of achieve approximately 97% to 99% pure ethylene glycol or propylene glycol that is displayed as a clear liquid. The clear liquid, fully separated glycol is then pumped by pump 107 into a glycol holding tank (FIG. 4). As shown in FIG. 4, a pair of glycol holding tanks 111, 113 are employed with first tank 111 being a localized tank disposed adjacent to the device 10, and second tank 113 being shown as a larger tank, which, because of its size, may be disposed remotely from the separator device 10. Alternately, the second tank 113 can represent a railroad car or truck tanker employed for transporting the purified glycol to a processing facility.

The purified glycol is retained in the pure glycol tank 111, 113. From the glycol tank 111, the purified glycol can be transferred into a transport truck for transport back to a facility that produces new, recycled ethylene glycol or propylene glycol coolant. Alternately, the pure glycol can be transferred to a mixing tank 133 (FIG. 4), in which supplemental coolant additives can be added to the purified glycol so that the resultant mixture can be used within the same plant, as “fresh” coolant.

As best shown in FIG. 4, the post-purification processing portion of the device and process can include an additive storage tank 121 for storing additives for delivery into the reprocessed glycol anti-freeze composition, and the distilled water tank 104 which has captured the water that was “boiled off” the spent coolant mixture. Water from tank 104 and additives from tank 121 are mixed in an additive mixture tank 123. The water/additive mixture is then transferred to one or more mixing chambers 125, 127 where the water/additive solution is mixed with purified glycol to form the finished “fresh coolant” which is then transferred to the finished product storage tank 131.

As best shown in FIG. 6, a moisture sensor 154 is coupled to the outflow port 148 of vacuum separator 83. The moisture sensor 154 determines the moisture content of the air stream flowing out of the outflow port 148. The moisture sensor 154 ensures that the air coming out of the vacuum distillation includes a moisture content that is at or below a predetermined level. The way in which the moisture sensor operates is that the moisture sensor is set so that it should be coupled to the outlet valve 160 of the vacuum separator.

Additionally, the moisture separator 154 should be set at a particular moisture content level. So long as the moisture sensor 154 senses a moisture percentage that is below the predetermined level, the moisture sensor 154 will then know that the glycol is sufficiently moisture free so as to be considered “finished”. As such, the outlet from the glycol collector should enable the glycol to be transferred to the molecular sieve 110 (FIG. 3).

However, the moisture content level spiking above the predetermined level, indicates that the moisture content of the glycol is above acceptable levels. In such case, the outlet 110 will recycle the glycol into the tank 99, and preferably through the vacuum separator spinning disc mechanism, so that further water can be removed, until the moisture content sensed by the moisture sensor 154 returns to at or below the predetermined level.

The pump 107 then pumps the purified glycol into the purified glycol storage tanks 111, 113. The purified glycol within the glycol storage tank 111, 113 is stored until it is either transferred to a transport vehicle or otherwise, sent for further processing.

If further processed, the purified glycol can then be passed through a refractor type sensor 152, and into an in-line primary 125 and secondary 127 mixer (FIG. 4). The in-line primary 125 and secondary 127 mixers mix the pure glycol with distilled water to form a 50-50 “premix” glycol that has a desired relative percentages of distilled water and pure glycol. In addition to the distilled water, a supplemental coolant additive can be added to the purified glycol from additive tank 121, so that reconstituted, clean, recycled glycol-based coolant will be created, and delivered to the finished product storage.

Alternately, the pure glycol can be mixed into the in-line primary 125 and secondary 127 mixers with just supplemental coolant additive, and without the distilled water. In such a case, one would create a “full strength” coolant mix that is composed almost entirely of glycol and additives that could then be transferred to a bottling facility, or otherwise mixed at some other time with water to form the coolant in the proper mix percentages.

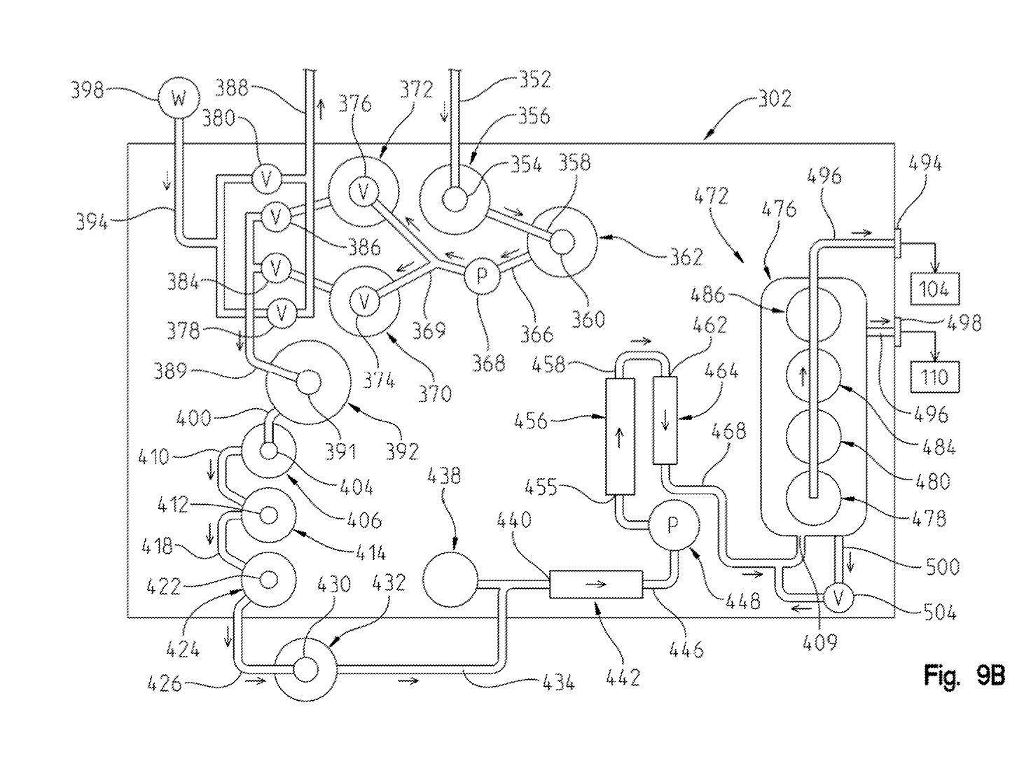

Typically, a “pre-mixed” solution is formed to comprise a mixture of 50% distilled water and 50% ethylene glycol, to achieve its final pre-diluted volume. Additionally, the additives such as aluminum, copper, lead, iron, chloride and acids must be added back into the system since they are removed from the coolant during the purification process. The desired chemical and physical requirements for Recycled, Pre-diluted (50/50 H₂O/ET-Glycol) anti-freeze are shown at FIG. 9.

TABLE 1
Desired Chemical and Physical Requirements for Recycled
Pre-diluted (50% EG by volume) Antifreeze

| Property | Value | | rest Method |
|---|---|---|---|
| Freeze Point, F. | −34 | min | ASTM D1177¹ |
| pH | 7.5 to 11.0 | | ASTM D1287 |
| Reserve Alkalinity, mL | 6.0 to 16.0 | | ASTM D1121 |
| Ash content, mass % | 2.0 | max | ASTM D1119 |
| Glycolate, ppm | 900 | max | LC² |
| Formate, ppm | 300 | max | LC |
| Chloride, ppm | 25 | max | LC |
| Iron (Fe), ppm | 10 | max | ICP/AA³ |
| Lead (Pb), ppm | 5 | max | ICP/AA |
| Copper (Cu), ppm | 5 | max | ICP/AA |
| Aluminum (Al), ppm | 5 | max | ICP/AA |

| | | |
|---|---|---|
| Appearance | Translucent, | Visual |
| | no visual | inspection |
| | contaminants | |

¹ASTM standards are available directly from ASTM, 100 Barr Harbor Drive, West Conshohocken, PA, 19428-2959.
²LC—liquid chromatography or other reliable technique with similar accuracy
³IPC/AA—atomic adsorption, atomic emission, or other reliable technique with similar accuracy.

An alternate embodiment continuous flow coolant purification system and device is shown in FIG. 9. The device 300 shown in FIG. 9 is believed by Applicants to include several refinements over the device shown in FIGS. 1-4, and appears to represent a more preferred embodiment.

An alternate embodiment 300 is designed to include a container 302 such as a 53 foot ISO shipping container for housing some or all of the components. Information about ISO shipping containers can be found at www.shippingcontainers24.com, which descriptions are incorporated herein. It will be noted that some of the components are shown inside the container 302, whereas others are shown being outside the container 302. For reasons of size and safety related primarily to notions of venting potentially flammable hydrocarbons, and isolating such hydrocarbons from possible sources of ignition, the first and second storage tanks 314, 324, oil separator 338, and activated charcoal filter 348 are preferably placed outside the container 302. However, in a device that is designed to be portable, these components can be placed in a separate container (or a separate compartment within the same container), with fluid connections between the container (or compartment) in which the first and second storage tanks 314, 324, oil separator 338 and activated charcoal filter 348 are placed, and the container (or compartment) in which many or all of the remaining components are placed.

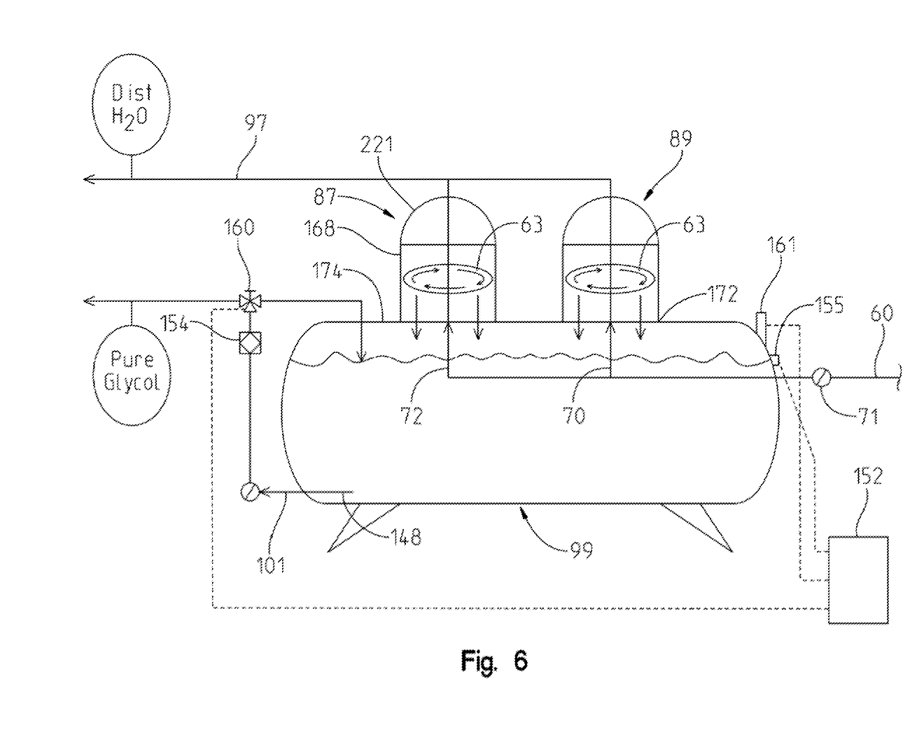

In the description below, size and quantity figures are given for some of the components, to illustrate one particular preferred embodiment of the present invention. The primary purpose for giving these dimensions is to better enable the disclosure for the reader. It will be appreciated however, that the device 300 of the present invention, and the first embodiment shown in FIGS. 1-8 are infinitely scalable. As such, the sizes of the components could be increased or decreased depending on factors such as space and desired throughput. Additionally, the size of particular components such as the oil water separator 338 and carbon absorption tank 348, can be up sized or downsized relative to other components in the system 300, to meet particular needs. For example, as stated above, spent coolant that is removed from automobile scrap yards tends to have a higher oil content than industrial propylene glycol waste that is removed from a hospital or industrial facility, and spent ethylene glycol coolant that is removed from automobile service facilities.

As such, if the device 300 is being used to purify oil from scrap yards, one might wish to increase the size and capacity of the oil/water separator 338 and charcoal absorber 348 to handle the increased oil percentage of the waste input stream. Additionally, the nature of some components might even allow the user to eliminate one or more of the components. It has been found by the Applicants that propylene glycol waste streams that are removed from industrial and commercial facilities such as hospitals, typically have a very low oil content. As such, one processing such propylene glycol waste streams may be able to do away with the oil/water filter separation 338 entirely, and forward the waste directly into a carbon absorption tank 348.

FIG. 9 is designed for semi-permanent placement, and used in a situation wherein a truck 304 having a liquid tank mounted on its bed 306 is employed for conveying waste from the site of generation such as an automobile service facility, junkyard or plurality of service facilities, to the treatment facility wherein the coolant processing device 300 resides.

Recovery hose 312 is coupled to the tank 306 of the truck 304 to drain the spent coolant from the truck tank 306. The waste stream that flows through the recovery hose 312 is deposited into a first and second storage tank 314, through the first tank inlet 315, and the second storage tank inlet 325 respectively.

Exemplary tanks 314, 324 that can be employed include 6,000 gal, plastic tanks, that are commercially available. Although two storage tanks 314, 324 are shown, the actual number of tanks employed is dependent largely upon the needs of the user. The tanks can all be designed to each receive all waste streams or alternately, can be designed to receive different types of waste. In this regard, each of the tanks 314, 324 may have its own recovery hose, to enable it to be individually coupled to the tank 306 of a truck 304, so that all of the material from the tank 306 of the truck 304 is placed in that particular storage tank (e.g. 314) with none going into the other storage tank 324. This regime may be useful where the operator wishes to segregate one waste stream, such as heavily oil laden waste removed from junkyards from a second waste stream, such as waste coolant removed from automobile service shops or propylene glycol removed from hospital facilities. Through such a segregation of waste, the operator can better adjust the process of device 300 to more efficiently handle the waste.

Each of the first and second storage tanks 314, 324 includes outlet pipes 318, 326 respectively, for removing the spent coolant content from the respective storage tanks 314, 324. First and second valves 320, 328 are inserted into the respective outlet pipes 318, 326, so that the user can selectively control the flow through the outlet pipes 318, 326.

Spent coolant flowing from the outlet pipes is directed to an inlet 356 of the oil/water separator 338. Oil/water separator 338 is generally similar to oil/water separator 12 that is discussed in connection with FIGS. 1-4. Although the oil/water separator 338 is highly useful when processing most automotive origin ethylene glycol fluids, the oil/water separator 338 may not be necessary when processing propylene glycol fluids that originate from hospitals and the like. Such propylene glycol fluids tend to have an oil concentration that is sufficiently low so as to not require processing by the oil/water separator.

Water flows out of outlet pipe 342 from the oil/water separator 338 and through valve 344 into an inlet 346 of the charcoal absorption tank 348. Charcoal absorption tank is similar to carbon absorber tank 39 discussed in connection with FIG. 1. The primary purpose served by the carbon absorption tank 348 is to capture hydrocarbons, such as oils in the spent coolant mixture and to soften the load to the filters. Preferably, the tank in which the charcoal is placed is filled to about one-third full with charcoal, leaving the top two thirds empty for receiving spent coolant.

The charcoal containing absorption tank 348 is placed upstream of bag filter 356 which is opposite to its positioning in the embodiment of FIG. 1. This upstream positioning of the carbon absorption tank 348 is done to enable the carbon absorption tank to be placed outside of the container 302. By keeping the carbon absorption tank 348 exteriorly of the container 302, one substantially reduces the quantity of volatile hydrocarbons in the spent coolant fluids, before the spent fluid enters the interior of the container 302. This helps to reduce the fire or ignition hazzard caused by the ignition of spent fluid, since the removal of the oil from the fluid helps to reduce the likelihood of a fire erupting.

The typical size of the tank 306 on the truck is between about 5,000 and 9,000 gallons (21,000 L and 34,000 L) on large trucks. The two storage tanks 314, 324 are preferably approximately 6000 gallon (22,712 L) tanks, and the oil/water separator 338 may be a 1500 gallon (5,678 L) tank that should enable a throughput of about 16 gallons per minute.

Spent coolant that emerges from the charcoal absorption tank 348 is passed through outlet pipe 352 and into the inlet 354 of the bag filter 356. Outlet pipe 352 passes through the wall of the container 302. In practice, the outlet pipe 352 can be coupled to a connector (not shown) that is mounted on the container, with a downstream end of the connector comprising a second pipe that directs fluid into the inlet 354 of the bag filter 356.

Bag filter 356 is generally similar to bag filter 16 shown in FIGS. 1-4. After passing through the bag filter, the fluid flows out of an outflow pipe 358, and into an inlet 360 of a string wound filter 362. One difference between the embodiment shown in FIG. 9 and the embodiment shown in FIG. 1 is that the string filter 362 and bag filter 354 are shown as being housed in separate containers, whereas they are shown as being housed in the same container in the embodiment shown in FIGS. 1-4.

Fluid that flows out of the outlet pipe 366 of the string wound filter 362 flows into pump 368. Pump 368 is preferably an AMPCO 7.5 hp centrifugal force 2.5 inch stainless steel pipe having a five inch propeller. Examples of such pumps can be found on AMPCO's website at www.ampcopumps.com.

The outlet pipe from the pump 369 conveys fluid from the downstream side of the pump to the inlets 374, 376 of respective first 370 and second 372 duplexing sand filters. The valves, such as valve 344 can be industrial strength valves that are sized for the size of pipe and the flow capacity that is appropriate for the task provided by the device 300. An example of a valve that will work in many places within the system is a two inch NIBCO ball valve that is rated at 275 psi at 180° F. Valves manufactured by NIBCO can be seen on NIBCO's website at www.nibco.com Additionally, similar industrial valves that would work as well if not better with the present invention are those valve manufactured by Nexus Valves of Indianapolis, Ind. at that can be viewed on Nexus' website at www.nexusvalve.com.

Double duplexing sand filters 370, 372 are disposed in parallel and are used on an alternating basis. In particular, the valve arrangement is designed to allow spent coolant to pass first through the first duplexing sand filter, and then through the second duplexing sand filter sequentially. Additionally, back flush capabilities are provided. The sand filters 370, 372 are designed for filtering out particulate matter from the spent coolant mixture.

The first sand filter tank 370 includes a first or upstream inlet valve 374, and a first sand filter outlet valve 378 disposed at the outlet port of the first sand filter. Similarly, the second sand filter 372 includes a second sand filter tank inlet valve 376, and a second sand filter outlet valve 380 disposed respectively at the inlet and outlets of the second sand filter 372. Additionally, a first sand tank back flush valve is fluidly coupled to the outlet valve 378 of first sand tank 370, and the second sand tank back flush valve 386 as fluidly coupled to the outlet valve 380 of the second outlet tank 372.

The six valves 374-376 serve various functions. The first inlet valve 374 controls the inlet to the first sand filter 370. The second valve 376 controls the inlet to the second sand filter 372. Each of the first and second valves 374, 376 are on/off valves, that either allow water to flow there through and into the sand filters, or are shut off, to prevent the water there through. The first and second outlet valves 378, 380 control the respective outlets to the first and second sand filters 370, 372. The first and second back through valves 383, 386 control the back flush operation.

It is also important to note that there are several variable courses of action for fluid that flows out of the outlets of the first and second sand tanks 370, 372. The coolant that is processed by and flows through the sand tanks 370, 372 can be directed to an outflow pipe 389, that will conduct the coolant to the inlet 391 of a resin tank 392. Alternately, the output from the first and second sand tanks 370, 372 can be directed back into a re-circulation pipe 388 that includes a valve 390, and ultimately transports the fluid back to the inlet 346 of the carbon absorption tank 348. These fluids that are directed to flow into the carbon absorption tank are then directed to flow through the bag filter 354, string wound filter 362 and sand absorption tank 370 or 372, for further purification. The exact percentage of fluid that is returned for re-circulation, versus the percentage of fluid that is directed to outlet pipe 389 will likely vary depending upon the purity of the end product desired, the throughput requirements of the device 300 and the condition of the waste stream that is presented to the device 300.

The operation of the sand tanks in a forwardly filtering flow, and in a back flush mode will now be described.

Typically, the first operation that will occur on startup of the device 300 is that spent coolant that is discharged from pipe pump 368 will be directed to the first sand duplexing tank 370. To do that, the inlet valve 374 and outlet valve 378 of the first sand tank 370 is opened. Through opening these two valves 374, 378, spent coolant can flow into the interior of the first sand tank 370, flow through the sand within the first sand tank 370 to be purified and then flow out of the first sand tank 370 through valve 378. Fluid that passes out of valve 378 is then directed to either to the outlet pipe 389 and then into resin tank 392, or alternately, is re-circulated through re-circulation pipe 388 into the charcoal absorber filter 348. During this time, the inlet 376 and outlet 378 valves of the second tank 372, and both back flush valves 384, 386 remain closed.

After a predetermined period of time, the valves 374 and 378 of the first tank 370 are shut and the inlet valve 376 and outlet valve 380 of the second tank 372 are opened. In the second part of the cycle, spent fluid that is discharged through pump 368 is passed through the inlet valve 376 into the second sand filter tank 372, wherein the fluid can pass through the sand contained within the sand tank 372 and emerge out the outlet valve 380 that is also open. Fluid that flows through the outlet valve 380 can either be directed to outlet pipe 389 or re-circulation pipe 388.

After a predetermined period of time, the inlet and outlet valves 376, 380 of the second sand tank 372 are closed, and the inlet and outlet valves 374, 378 of the first sand filter 370 are opened. This alternating arrangement has been found by the Applicants to be efficient in maintaining a good throughput through the tanks 370, 372.

Sand filters 370, 372 have a tendency to clog after a certain period of use. To unclog the sand filters 370, 372, the sand filters are back flushed that means that fluid is run through the sand filters 370, 372 in a reverse direction. Back flushing is a common procedure, and is often used with other sand filters, such as sand filters that one might have in a commercial swimming pool.

When a back flushing operation is being performed, the sand tanks 370, 372 are back flushed one at a time. During the first portion of the back flushing operation, the first back flush valve 348 is opened. Fluid from a fluid source, such as water source 398 is passed through a back flushing material introduction pipe 398 so that it may enter the back flush valve 384. Additionally, outflow valve 378 and inflow valve 374 are opened, to allow water to run in a reverse direction and be back flushed out of the first sand tank 370 to clean the first sand tank 370. To better agitate the sand in tank 370, the water is pulsed through the sand which may be accomplished through the addition of air.

This pulsating back flushing phase is followed by a quiescent phase, wherein back flushing water ceases for 12 minutes to give the sand time to re-settle. The pulsing operation can then resume for another seven minutes to back flush the sand, followed by 12 minutes of quiescence to allow the sand to resettle.

The sand tanks 370, 372 are back flushed in an alternating arrangement. For example, after water is run backwardly through sand filter 370, and air is pulsed through sand filter 370, the back flush valve 384 can be closed at the beginning of the quiescent period. At that time, the outlet valve 378 and inlet valve 374 are also closed to prevent the flow of fluid in the sand tank. Concurrently, the back flush valve 386 of the second sand filter 372 is opened, along with outlet valve 380, and inlet valve 376. The second sand tank is then subjected to the same alternating back flush and pulsing air for seven minutes, followed by a 12 minute quiescent period.

The sand filters should be designed to have excess capacity, in order to allow time for the fluid to pass through the sand, while maintaining appropriate throughput. In a preferred embodiment, the Applicants have used a pair of sand filters 370, 372 each of which has a capacity of approximately almost 85,000 gallons (321,760 L) per day. The sand filters 370, 372 are preferably housed in upright cylindrical tanks, that, in the most preferred embodiment, have an outer diameter of approximately 34.625 inch and an inner diameter of 33.825 inches. Each of the two tanks 370, 372 is also approximately 50 inches (127 cm).

The valves 374, 376, 378, 380, 384, 386 are controlled by a set of six solenoids, that are arrayed on a solenoid control panel with a 24 volt controller (not shown). The valves 374-386 are pneumatically operated by the solenoids and pneumatic lines extend between the six valves 374-386 and the controller and pneumatic solenoids that are placed in the control panel.

After exiting the sand filter tanks 370, 372, spent coolant to be further processed, is directed throughout outlet pipe 389 and into outlet 391 of resin tank 392. Resin tank 392 in the most preferred embodiment comprises an approximately 75 gallon (283,906 L) tank that contains a resin filter. The resin filter should be a type of a cation type of resin filter. An example of cation resin that will work in the present invention is DOWEX HCR-5 (Dow Chemical Canada, LLC); USF C-211 (U.S. Filter); Mono Plus® S-100 (Lewatit); C-249 (IONAC); SK-IB (Diaion); and C-100 Purolite).

These cation exchange resins are designed to filter out metals, dissolved metals and dissolved metal salts.

After flowing through the resin tank 392, the spent coolant to be processed flows through outlet pipe 400, to a series of three micron sized membrane filters 406, 414 and 424. The micron-range membrane filters each are capable of filtering particles of smaller sizes, in a progressive manner.

The first micron membrane filter 406 is a one-micron filter, that is capable of capturing particles that are generally one-micron or larger. An example of such a filter that will work in the present invention is the APO.5P 65SHS one-micron that is manufactured by Strainrite Filters. Information about Strainrite Filters can be found at their website at www.strainrite.com.

Second filter 414 is a 0.5 micron filter, that is also manufactured by Strainrite Filters. The part number for an exemplary micron filter that would work is the Strainrite AP1TS65 SHS 0.5 micron filter. The third filter is a 0.1 micron filter. The 0.1 micron filter is capable of capturing particles that are generally 0.1 micron or larger, and is also manufactured by Strainrite Filters.

The three filters are arrayed in series so that spent fluid first flows through the inlet 404 of first filter 406 and then, out the outlet pipe 410. The fluid is conducted by outlet pipe 410 to the inlet 412 of the second filter 414 which is the 0.5 micron filter. The fluid then passes through the 0.5 micron filter and exits the second micron membrane filter 406 and passes into outlet pipe 418 where it is conducted to the inlet 422 of the third micron filter 424. Third micron filter 424 enables the fluid to pass through the filtered material contained therein to filter out particles, such as metal particles and other particulate matter generally greater than 0.1 micron in size. The fluid flows out of the output line 426. The three membrane filter 406, 414 and 424 are intended primarily for filtering out fine metals that have found their way into the coolant, such as cadmium, selenium and lead.

The outlet pipe 406 from the third filter 424 passes through the wall of the container 302 to the heater 432 that is disposed outside the confines of the container. It is believed by the Applicants that it is preferable to maintain the heater outside the container, to reduce the risk of fire within the interior of the container.

Currently, the preferred type of heater 432 is an industrial strength and sized, hot water heater. The water tank of the heater should be sized so that it can continuously provide a flow of processed coolant at the desired flow rate of the heated coolant. An example of such a heater is a 75,000 BTU, 90 gallon gas water heater manufactured by Rheem-Ruud of Atlanta, Ga. Because of the vacuum pulled by the vacuum separator 472, the water that emerges into the outlet pipe 434 downstream of the heater 432 does not need to be heated up to 100° C. (38° F.), but rather, only needs to be heated up to approximately 144° F. (62° C.).

Because of its increased efficiency and lower operating costs, the Applicants believe that gas heaters are generally preferable to electric heaters. Because of the flame employed in a gas heater, the gas heater is preferably placed outside the container 302, in a well vented area that is isolated from an area where volatile, combustible fumes collect so that a spark or flame from the heater 432 will not cause any vapors to catch fire or explode. The outlet pipe 434 from the heater leads into a flow meter 442.

A pressure buffer tank 438 is placed in fluid (gaseous) communication with the outlet line 434. The pressure balance buffer tank 438 comprises a large tank for providing the capacity to hold a large volume of air or other gas. The buffer tank has pressurized air contained therein that is normally kept at about 32 psi. This 32 psi air pressure within the buffer tank helps to balance the air in the line that leads to the high pressure pump 448 at an appropriate pressure.

Pressurized fluid in line 484 flows through the flow meter 442. The flow meter is provided to determine the amount of fluid that is flowing through the system. The flow meter 442 performs no separation function or cleaning function on the fluid itself, but rather serves as a gauge.

The outlet from the flow meter conducts fluid to the high pressure pump 442. An example of a high pressure pump that will work with the present invention is a 7.5 hp high pressure pump. The high pressure pump pumps the fluid up to 300 psi so that fluid can be pumped successfully through the first and second membranes 456, 464.

In a preferred embodiment, the membrane filters 456, 464 will handle a concentrate of 24,000 gallons (321,760 L) of concentrate per day at 300 psi and 8,000 gallons (30283 L) per day of permeate. The purpose of the membrane filters is to remove water from the spent coolant in the mixture. The type of membrane employed should be a reverse osmosis membrane, and preferably one capable of nano-filtration. The membrane filters 456, 464 are capable of removing sufficient water from the spent coolant passing there through, so that the effluent from the membrane filters should contain about 20% water and 80% glycol. Examples of filters that will work are the Filmtec S3M membrane filters that are manufactured by the Filmtec Corporation, a subsidiary of Dow Chemical Company.

The spent coolant flows from the outlet of pump 448 into the inlet 455 of the first membrane filter 456. The water separated in the membrane filter 456 is then carried away from the system, allowing spent water removed (or partially dried) coolant to flow downstream in the system through outlet pipe 458 into the inlet 462 of the second membrane filter 464. The spent coolant then passes through the second membrane filter 464 wherein more water is removed from the spent coolant. The removed water is carried out of the system, or otherwise treated by the system. The further dried spent coolant then flows through outlet pipe 468 into an inlet 469 of the vacuum separator.

Vacuum separator 472 includes a tank 476 and four separator heads 478, 480, 484, 486. The separator heads are preferably designed to each be constructed similarly to the separator head 114, shown in FIG. 7B. As shown in FIG. 7B, the separator head includes a plurality (here shown as four), rotating disks 128, 130, 132, 134. A stationarily positioned water inflow pipe 140 includes a plurality of sprinkler heads 142. The heads 142 spray water onto the upper surfaces 138 of the spinning disk members 128-134. The spinning of the disks carries the heated fluid placed thereon radially outwardly, as a thin film. The heated fluid, when subjected to the vacuum within the low pressure tank, and the thin film that forms on the disks 128-134 helps to separate water from glycol, by the water being “boiled off” and thereby separating from the glycol in the coolant.

By dispensing the spent coolant on to the disk 138 as a thin film, the surface area of the spent coolant increases substantially, thus allowing a greater number of water molecules to directly contact the low pressure vacuum atmosphere of the tank. This increased exposure of the water molecules increases the rate at which the water molecules boil off of the spent coolant, when compared to molecules disposed in a tank like environment, where only the surface water molecules are in direct contact with the low pressure atmosphere.

The separated water that is boiled off is conducted upwardly out the aperture 488 in the lid 168 of the separator 114, and is conveyed to distilled water outlet pipe 490. The distilled water carried off from the distilled water outlet pipe 490 can then be conducted to a condenser 102 to facilitate its conversion back to liquid water and ultimately to a distilled water tank 104. The condenser 102 and distilled water tank 104 are generally similar to those shown in FIG. 3, and may be disposed either within container 302, or outside container 302.

Purified glycol is pulled off of the bottom of the tank, as the glycol component that is placed onto the spinning disks 128-138 is directed radially off the radially outer edge of the disks 128-134 and then falls downwardly into the glycol tank 99, as discussed above in connection with FIGS. 6, 7 and 8.

Glycol can be pulled out of outlet 496 and directed to a downstream member in the processor such as the molecular sieve 110 (see FIGS. 3 and 4). Further processing of the now purified glycol occurs in accordance in this embodiment with the teachings disclosed above in connection with the components of the first embodiment, such as are shown in FIG. 4 and discussed in the text that accompanies FIG. 4.

Additionally, glycol can be pulled out of outlet 500 passed through valve 504 and redirected into the inlet pipe 468 into the vacuum separator 472. When so introduced, the re-circulated glycol will be deposited by pipe 140 onto the spinning disks 128, 138 of the spinning disk assembly, to further help evaporatively remove water from the purified glycol.

In other respects, the readers attention is referred back to the description of FIG. 1, that describes the further and final processing of the distilled water, and purified glycol that emerges from the low pressure separator 472.

Having described the invention in detail with reference to certain preferred embodiments, it will be appreciated that the examples given are exemplary, and not limiting, and that the scope and spirit of the present invention is limited only by the claims, the law and the prior art.

1. A fluid processing device for recycling a previously used water and glycol containing fluid by removing contaminants including hydrocarbon, metals, particulates and water contaminants from the water and glycol containing fluid; comprising
(1) a particulate filter for removing particulates,
(2) an activated carbon filter for removing hydrocarbon contaminants,
(3) a micron-sized filter for removing at least one of particulate and metal contaminants,
(4) a high pressure membrane filter for removing water contaminants,
(5) a heater for heating the glycol containing fluid to a temperature at least near the boiling point of water in a predetermined reduced pressure atmosphere,
(6) a low pressure separator having a tank kept generally at or near the predetermined reduced pressure for removing additional water from the water and glycol containing fluid, the low pressure separator including a first exit port for removing separated water from the separator as steam, and a second exit port for removing substantially water free glycol based fluid from the low pressure separator.

2. The fluid processing device of claim 1 wherein fluid processing device produces a cleaned glycol containing fluid containing less than about five percent water.

3. The fluid processing device of claim 1 wherein the fluid processing device produces a clean glycol containing fluid containing less than about three percent water.

4. The processing device of claim 1 further comprising a molecular sieve for removing additional water from the used glycol and water containing fluid, and wherein the glycol and water containing fluid comprises used coolant fluid removed from a cooling system.

5. The processing device of claim 1 further comprising an additive adding member for adding performance additives to the clean glycol containing fluid to enhance the performance characteristics of the cleaned glycol containing fluid when such fluid is used in another cooling system.

6. The processing device of claim 1 further comprising a water adding station for adding clean water to the cleaned glycol containing fluid to dilute the glycol containing fluid to a preferred dilution mixture for adding to a cooling system.

7. The fluid processing device of claim 1 wherein the low pressure separator includes a tank portion and a water separation portion, the water separation portion including
a fluid inlet pipe for conducting used water and glycol containing fluid into the separator,
a fluid dispensing outlet in fluid communication with the fluid inlet pipe,
a moving evaporation member disposed adjacent to the fluid dispensing outlet, the moving evaporation member including a surface for receiving the water and glycol containing fluid in a manner that forms a film of said fluid to promote the evaporation of water from said fluid by increasing the surface area of the fluid exposed to the predetermined vacuum conditions of the separator.

8. The fluid processing device of claim 7 wherein the moving evaporation member includes a rotatable shaft member, a motor for rotating the shaft member, and at least two plate like members fixedly coupled to the rotating shaft member for rotation with the shaft member.

9. The fluid processing device of claim 8 wherein the at least two plate members include at least a first and second disc shaped plate having an inner portion disposed adjacent to the rotating shaft and a radially outwardly disposed annular edge, wherein the fluid dispenser outlet dispenses the water and glycol containing fluid on the plate member adjacent to the inner portion to cause the fluid to form a thin film as it moves radially outwardly under the influence of centrifugal force toward the radially outwardly disposed annular edge, wherein water is evaporatively separated from the fluid by being boiled off and hence removed as water vapor from the first exit port, and the glycol concentrated fluid remaining after the removal of water is allowed to fall off the radially outwardly disposed edge, and into the tank.

10. The fluid processing device of claim 9 wherein the water separation portion includes a housing in fluid communication with and disposed above the tank portion, the housing including a barrel member having an upper surface, a lower surface, a generally hollow interior, and a lid member,
the lower surface being coupled to the tank portion, the hollow interior being sized for receiving the fluid dispensing outlet, the rotating shaft and at least first and second disk shaped plates, and wherein the lid member is sized and configured for sealingly engaging the upper surface of the barrel portion, the lid member including an aperture coupled to an outlet pipe for serving as an exit port for removing the separated water vapor.

11. The fluid processing device of claim 10 wherein the lid member is generally dome shaped to facilitate evaporation of the water and wherein the tank portion is disposed below the barrel assembly to receive the glycol concentrated fluid.

12. The fluid processing device of claim 9 wherein the second exit port of the separator has an inlet disposed in the tank portion of the separator for removing the glycol concentrated fluid, further comprising a first outlet pipe for conveying the glycol concentrated fluid to a downstream component of the fluid processing device, and a second outlet pipe for directing the glycol concentrated fluid to the fluid dispensing outlet to dispense the glycol concentrated fluid on the moving evaporator member.

13. The fluid processing device of claim 1 wherein the particulate filter for removing particulates includes a bag filter and a string wound filter arrayed in series to permit the fluid to flow first through the bag filter and then through the string wound filter.

14. The fluid processing device of claim 1 further comprises an oil water separator having a tank wherein water and glycol containing fluid is allowed to reside relatively quiescently to permit and to separate out from glycol and water in the fluid based on immiscibility and differences in density.

15. The fluid processing device of claim 1 further comprising at least one sand filter through which the oil and water containing fluid is processed for removing particulates from the glycol and water containing fluid, wherein the device includes valves and piping for permitting fluid to be run backwardly through the at least one sand filter to back flush and thereby clean the at least one sand filter.

16. The fluid processing device of claim 1 wherein the micron sized filter includes
a first micron filter for filtering out particulates having a size of greater than about 1.0 microns, a second micron filter for filtering out particulates having a size greater than about 0.5 microns, and a third micron filter for filtering out particulates having a size of greater than about 0.1 microns.

17. The fluid processing device of claim 1 further comprising a resin filter for filtering out ionic materials selected from a group consisting of metals, dissolved metals, metal salts and dissolved metal salts.

18. The fluid processing device of claim 1 wherein the heater is disposed upstream of a high pressure membrane filter for delivering heated glycol and water containing fluid to the high pressure membrane filter further comprising a pump disposed upstream of the high pressure membrane filter for elevating the pressure of the glycol and water containing fluid delivered to the high pressure membrane filter, and wherein the membrane filter includes first and second high pressure membrane filters have openings of sufficiently small size to permit the membrane filters to employ an osmotic process for removing water from water and glycol containing fluid.

19. A process for recycling a previously used water and glycol containing fluid by removing contaminants including hydrocarbons, metals, particulates and water contaminants from the water and glycol containing fluid comprising passing said used water and glycol containing fluid through the device of claim 1 to form a contaminant and water reduced glycol composition containing at least about 95% glycol.
